(19) United States
(12) Patent Application Publication
(10) Pub. No.: US 2008/0144183 A1
(43) Pub. Date: Jun. 19, 2008

(54) COMPACT THREE COLOR LASER SYSTEM WITH LIGHT INTENSITY SENSOR

(75) Inventors: Min-Xian M. Zhang, Inverness, IL (US); Tomasz L. Klosowiak, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/612,240

(22) Filed: Dec. 18, 2006

(51) Int. Cl. G02B 27/14

(52) U.S. Cl. 359/634; 359/629

(57) ABSTRACT

A handheld electronic device (100), e.g., cellular telephone handset, is provided with a color laser projector system (300) that includes an optics module (112) includes a large green laser module (316) and smaller red (314) and blue (318) laser modules in a compact arrangement in which the red (314) and blue (318) laser module are arrange within a dimensional extent D1 of the green laser module (316) in a direction that is perpendicular to a direction in which a green laser beam (426) is emitted. The optics module (112) uses a single photo-detector 328 to sense the intensity of laser beams emitted by the three laser modules (314, 316, 318). A prism can be used to direct light to a bare chip (804) photo-detector (328). Alternatively, a right angle mounted surface mount photo-detector (328) can be used.

### FIELD OF THE INVENTION

This invention pertains to laser image projectors for use in handheld electronic devices.

### BACKGROUND

During the past decade handheld electronic devices such as mobile telephones, portable video player, personal digital assistants (PDA) and portable game consoles, have come into widespread use. Moreover, continued progress in electronic integration, has enabled the development of ever more powerful devices, to wit-the handheld devices of today have processing power comparable to personal computers of a decade ago. Thus, it is possible for handheld electronic devices to run many useful applications that are run on personal computer, such as web browsers, image viewers and video players, for example. One limiting factor, in regards to handheld devices is their small screen size. The small screen size somewhat discourages prolonged use of text and graphics intensive applications. To address the small screen size, it has been proposed to incorporate small laser based image projectors within handheld devices. To provide a full color display a three laser system can be used. Although semiconductor diode lasers that operate a suitable wavelengths in the blue and red parts of the visible spectrum are available, for the green laser a solution that uses a diode pumped frequency doubled laser has been proposed. However, such a laser requires a relatively large amount of space and a limited amount of space is available within handheld devices (e.g., cellular telephone handsets) which must also accommodate other components such as the cellular radio, speaker, microphone, battery and optionally other components as well. Thus, there is a need for very compact laser projector systems.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a cut-away front perspective view of a handheld electronic device that includes a laser projector according to an embodiment of the invention;

FIG. 2 is a sectional side view of the handheld electronic device shown in FIG. 1;

FIG. 3 is a block diagram of a laser projector incorporated into the handheld device shown in FIGS. 1-2;

FIGS. 4-7 are plan views of optics modules used in the laser projector shown in block diagram form in FIG. 3 according to different embodiments of the invention;

FIG. 8 is a fragmentary perspective view of a prism that directs light to a photo-detector used in the optics modules shown in FIGS. 4-7 according to an alternative embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to laser image projectors for handheld electronic devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of image projection described herein. The non-processor circuits may include, but are not limited to, a radio receiver, a radio transmitter, signal drivers, clock circuits, power source circuits, and user input devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

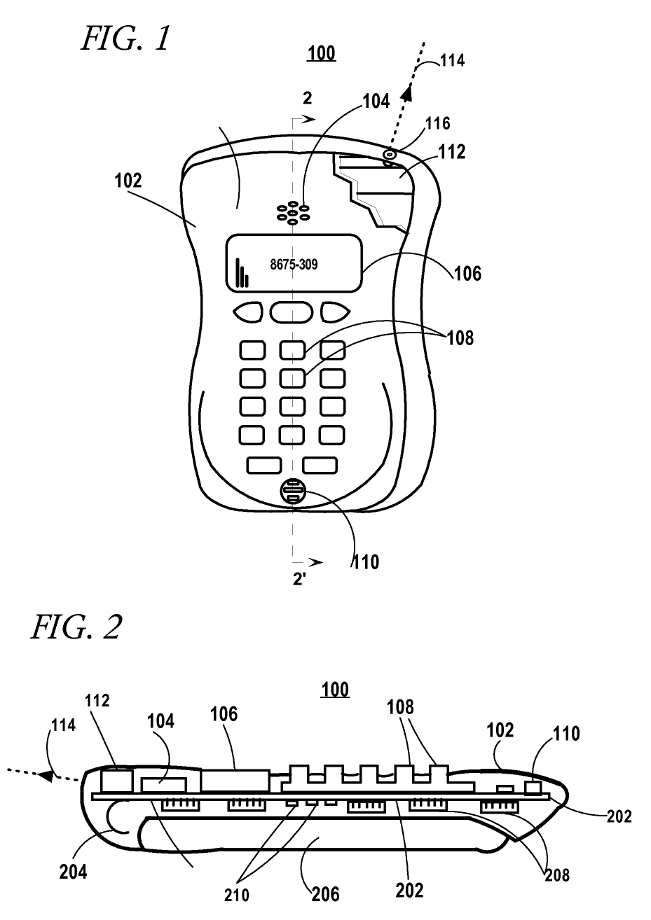

FIG. 1 is a cut-away front perspective view of a handheld electronic device 100 that includes a color laser projection system according to an embodiment of the invention and FIG. 2 is a sectional side view of the handheld electronic device 100 shown in FIG. 1. As shown in FIG. 1, the handheld electronic device 100 takes the form of a “candy bar” style mobile telephone, however alternatively the handheld electronic device 100 can take the form of a PDA, portable video player, handheld game console, “clamshell” style mobile telephone or other device. The device 100 has a housing 102 that supports and encloses a number of components including an earpiece speaker 104, an internal display 106 (e.g., a LCD or ePaper), a keypad 108, a microphone 110, circuit board 202, antenna 204 and battery 206. The circuit board includes integrated circuits 208 and discretes 210. The housing 102 also encloses an optics module 112 of a color laser projector system. In as much as the device 100 is desirably small, to meet consumer demand, there is not much space for the optics module 112. The optics module 112 emits an imagewise modulated laser beam 114 through an opening 116 in the housing 102.

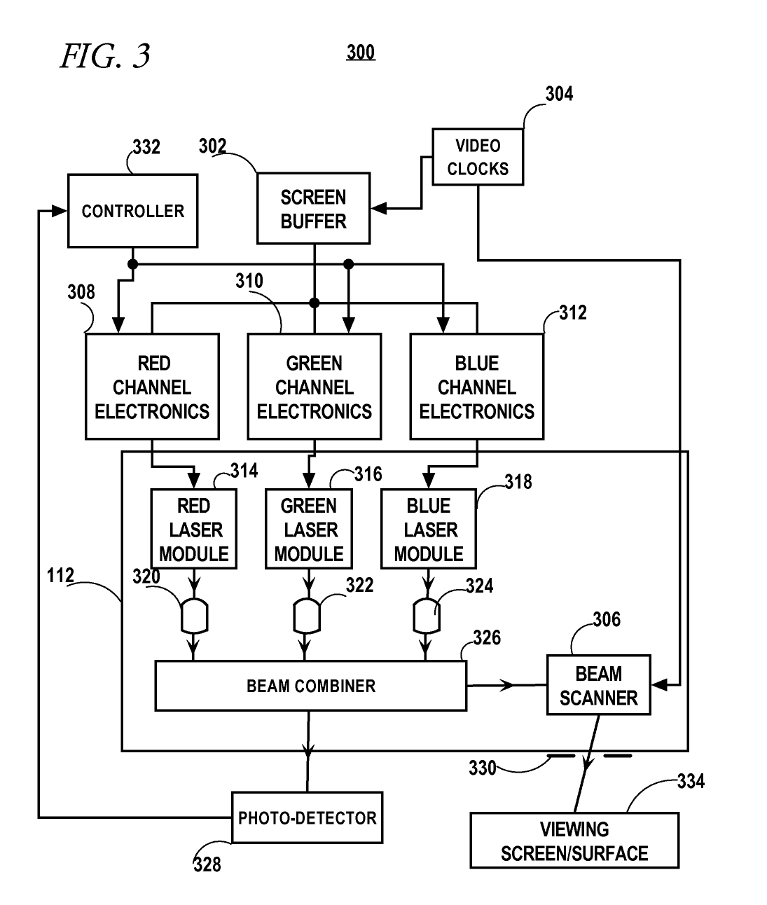

FIG. 3 is a block diagram of a color laser projector system 300 incorporated into the handheld electronic device 100 shown in FIG. 1 or other handheld device according to an embodiment of the invention. An entry point of the system 300 is a screen buffer 302. Two dimensional arrays of discrete quantized digital pixel brightness values are written into the screen buffer 302. Each discrete quantized pixel brightness value typically is encoded in a plurality of binary bits (e.g., 8 bits) so that more than two (e.g., 256) intensity values can be encoded. Each two dimensional array represents a frame to be projected by the system 300. Separate two dimensional arrays can optionally be provided for each of multiple colors. Image data written into the screen buffer 302 may come from disparate sources. For example, an operating system of the device 100 may write pixel brightness values for background areas (known in the context of windows type operating systems as the desk top) and application window frames. Areas of the projected display that include video can be written into the screen buffer 302 by specialized video decoder chips.

One or more video clocks 304, e.g., a pixel clock, a row clock and frame clock are coupled to the screen buffer 302 and to a beam scanner 306. The video clocks 304 clock the pixel brightness values out of the screen buffer 302, into red channel electronics 308, green channel electronics 310, and blue channel electronics 312. Alternatively, more than three colors are used to achieve a display with an increased color gamut. The color channel electronics 308, 310, 312 suitably comprise digital-to-analog converters coupled to video amplifiers with settable gains and biases.

The red, green and blue color channel electronics 308, 310, 312 are coupled respectively to a red laser module 314, a green laser module 316 and a blue laser module 318. Briefly, the color channel electronics 308, 310, 312 serve to generate drive signals to drive the laser modules 314, 316, 318 based on the pixel brightness values received from the screen buffer 302. Laser diodes that emit blue and red wavelengths of light are suitably used as the blue laser module 318 and red laser module 314 respectively. A diode pumped frequency doubled laser is suitably used as the green laser 316.

Laser beams emitted by the red, green and blue laser 314, 316, 318 are coupled through a red channel lens, 320, a green channel lens 322 and a blue channel lens 324 to a beam combiner 326. As disclosed below in more detail, the beam combiner 326 suitably comprises a number of mirrors, including dichroic mirrors. The red, green and blue channel lenses 320, 322, 324 serve to collimate or establish designed angles of divergence of the laser beams. As disclosed below the green channel lens 322 is a compound lens and alternatively the blue channel lens 324 and/or the red channel lens 320 is also a compound lens.

A combined single beam produced by the beam combiner 326 impinges the beam scanner 306. The beam scanner 306, can for example take the form of one or more piezoelectric mirror devices, MicroElectroMechanical System (MEMS) mirror devices, or rotating mirrors, for example. The beam scanner 306 scans the combined beam over a viewing screen or other surface 334. The beam scanner 306 suitably scans the combined beam in a raster pattern, but may alternatively use a vector pattern. The beam scanner 306 is kept in sync with pixel brightness values coming out of the screen buffer by supplying one or more signals from the video clocks 304 to the beam scanner 306.

A photo-detector 328 monitors light leaked by the beam combiner 326. The leaked light is proportional in intensity to light emitted by laser modules 314, 316, 318. The beam scanner 306 directs light out of the device through a stop 330. The stop 330 may be embodied as a hole in the housing 102 of the device 100. The scanner 306 can be operated to direct light beyond an angular range of a projected image so that light is blocked by the stop 330. This may be done every frame or as needed. While the light is blocked by the stop 330 the laser module 314, 316, 318 may be driven at specified input power levels while the photo-detector 328 is used to sense the intensity of light leaked by the beam combiner 326. The bias and/or gain of electrical signals used to drive the laser modules 314, 316, 318 can then be adjusted based on the intensity of the leaked light. In this manner the biases corresponding to the lasing thresholds of the laser modules 314, 316, 318 can be determined and set. Additionally the drive signal gains required to maintain predetermined color balance and brightness of the laser modules 314, 316, 318 can be determined and set. A controller 332 is coupled to the photo-detector 328 allowing the controller 332 to receive signals representative of light intensity. The controller 332 is also coupled to the color channel electronics 308, 310, 312 so that the controller 332 can digitally set biases and gains of video amplifiers used in the color channel electronics 308, 310, 312. Co-pending patent application Ser. No. 11/275,206 (Docket No. CML02735T) entitled “Method and Apparatus for Intensity Control of Multiple Light Sources” discloses a system that uses a single light sensor to sense the light intensity emitted by three lasers.

Using the photo-detector 328 to collect light leaked from the beam combiner in lieu of using individual photo-detector that are positioned to collect light from each laser modules 314, 316, 318, avoids the problem of photo-detector cross-talk which is exacerbated by the need for a compact arrangement of the laser modules 314, 316, 318, and also removes the necessity to provide light leakage, e.g., from laser diode back mirrors, from each laser module, thereby improving laser slope efficiency and reducing lasing thresholds (laser threshold currents).

The optics module 112 includes the laser modules 314, 316, 318 channel lenses 320, 322, 324, beam combiner 326 and beam scanner 306. The video clocks 304, screen buffer 302 and channel electronics 308, 310, 312 are embodied in the integrated circuits 208 and discretes 210 mounted on the circuit board 202.

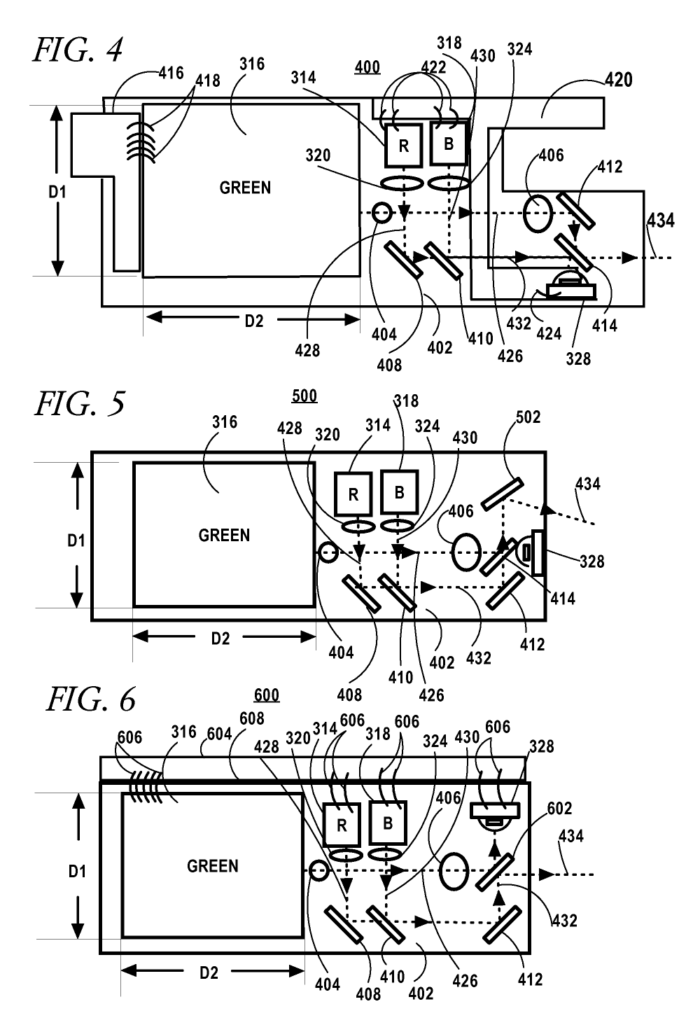

FIGS. 4-7 are partial plan views of the optics module 112 of the laser projector system 300 shown in block diagram form in FIG. 3 according to different embodiments of the invention. A first embodiment 400 of the optics module 112 is shown in FIG. 4. Referring to FIG. 4 a rigid substrate board 402 supports components of an embodiment of the optics module denoted 400 including: the green laser module (e.g., diode pumped, frequency doubled laser) 316, the red laser module (e.g., laser diode) 314, the blue laser module (e.g., laser diode) 318, the red channel lens 320, the blue channel lens 324, and the green channel lens which in the embodiments shown in FIGS. 4-7 is a compound lens that includes a primary lens 404 and a secondary lens 406, a first achromatic (e.g., protected silvered) folding mirror 408, a first dichroic mirror 410 (e.g., multilayer interference film), a second achromatic folding mirror 412, a second dichroic mirror 414, and the photo-detector 328. A first flexible printed circuit 416 is used to connect signal leads 418 to the green laser module 316 and a second flexible printed circuit 420 is used to connect signal leads 422, 424 to the red laser module 314, the blue laser module 318 and the photo-detector 328. Alternatively, in lieu of using two separate flexible printed circuits 416, 420 a single larger flexible printed circuit is used. As shown in FIGS. 4-7 the photo-detector 328 is a surface mount photo-detector that is mounted at a right angle to the rigid substrate board 402.

The green laser module 316, being a diode pumped frequency doubled laser is larger than the red laser module 314, and the blue laser module 318 which suitably take the form of diode lasers that directly emit red and blue wavelengths respectively. The green laser module 316 has a first dimension indicated as D1 in FIGS. 4-7 and a second dimension indicated as D2 in FIGS. 4-7. The green laser module 316 emits a green laser beam 426 parallel to a direction in which the second dimension D2 is measured. The red laser module 314 and the blue laser module 318 are positioned spaced from each other in a direction parallel to the first dimension D2 within an extent of the green laser module parallel to the first dimension D1. The latter arrangement makes for a compact optics module 112 which can be accommodated within a handheld electronic device (e.g., 100) without requiring the device 100 to be unduly enlarged to a degree that it inconveniences users desiring a compact device.

The red laser module 314 emits a red laser beam 428 that is collected and collimated by the red channel lens 320 and then reflected ninety degrees by the first achromatic folding mirror 408 through the first dichroic mirror 410. The blue laser module 318 emits a blue laser beam 430 that is collected and collimated by the blue channel lens 324 and then reflected by the first dichroic mirror 410. Thus, the first dichroic mirror 410 combines the red laser beam 428 and the blue laser beam 430 into a combined red-blue laser beam 432. The combined red-blue laser beam 432 passes through the second dichroic mirror 414. The green laser beam 426 is collimated by the green channel lens 322 (including the primary lens 404 and the secondary lens 406) and reflected ninety degrees by the second achromatic folding mirror 412 and reflected again ninety degrees by the second dichroic mirror 414. Thus, the second dichroic mirror 414 serves to combine the combined red-blue laser beam 432 with the green laser beam 426 forming a three-color RGB combined laser beam 434. The three-color RGB combined laser beam 434 then propagates to the beam scanner 306 (not shown in FIGS. 4-7) which can also be supported on the rigid substrate board 402. The first dichroic mirror 410 transmits red light (e.g., with 95 to 99% transmissivity) and reflects blue light (e.g., with 95 to 99% reflectivity), while the second dichroic mirror 414 transmits blue and red light (e.g., with 95 to 99% transmissivity) while reflecting green light (e.g., with 95 to 99% reflectivity). The characteristics of the second dichroic mirror 414 are not perfect, and may in fact be intentionally degraded by design, so that a small portion of red light and blue light is reflected by the second dichroic mirror 414 and a small portion of the green light is transmitted by second dichroic mirror 414. These small portions are referred to herein as leaked light. The leaked light is incident on the photodetector 328. The first dichroic mirror 410 and the second dichroic mirror 414 in combination with the first achromatic folding mirror 408 and the achromatic folding mirror 412 make up the beam combiner 326. The first dichroic mirror 410 and the second dichroic mirror 414 suitably comprise multi-layer thin film interference coatings. Manufacturing variances in the amount of leaked light can be handled by preprogramming reflectivity and transmissivity factors into the controller 332. The dichroic mirrors 410, 414 are set at 45 degrees to the laser beams 426, 428, 430, 432, 434.

An embodiment 500 of the optics module 112 shown in FIG. 5 differs from the embodiment 400 of the optics module 112 shown in FIG. 4 in that it is the combined red-blue laser beam 432 that is reflected ninety degrees by the second achromatic folding mirror 412, and the green laser beam 426 is incident on the second dichroic mirror 414 without first being reflected. Moreover, an additional third achromatic folding mirror 502 that reflects the three-color RGB combined laser beam 434 is provided. The orientation of the third achromatic folding mirror 502 can be set in order to direct the three-color RGB combined laser beam 434 at an angle appropriate for the beam scanner 306 and such that the three-color RGB combined laser beam 434 will exit the device 100 in a desired direction (e.g., from the front of the device 100).

An embodiment 600 of the optics module 112 shown in FIG. 6 differs from the embodiments 400, 500 shown in FIGS. 4, 5 in that a third dichroic mirror 602 that is used in lieu of the second dichroic mirror 414 substantially transmits green light (reflects a small portion) and substantially reflects blue and red light (transmits small portions) is used. For example the third dichroic mirror 602 may transmit 95 to 99% of incident green light and reflect 95 to 99% of red and blue light. In the embodiment 600, the photo-detector 328 receives the small portion of green light that is reflected by the third dichroic mirror 602 and small portions of the red light and blue light that are transmitted by the third dichroic mirror 602. In the embodiment 600 a single printed flexible circuit 604 is used to connect signal leads 606 to the red laser module 314, the green laser module 316, the blue laser module 318 and the photo-detector 328. The arrangement of the foregoing components proximate a single edge 608 of the rigid substrate board 402 facilitates using only the single flexible printed circuit 604.

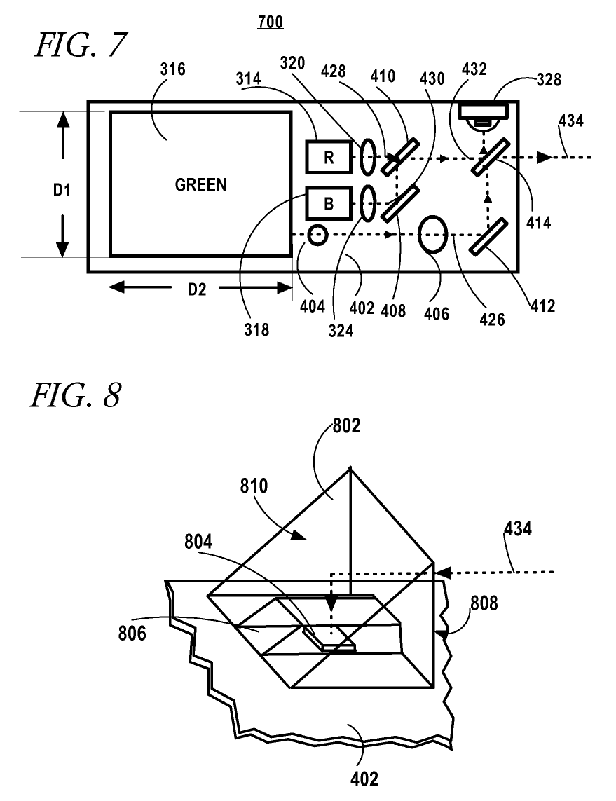

An embodiment 700 of the optics module 112 shown in FIG. 7 differs from the embodiments 400, 500, 600 described above in that the red laser module 314 and the blue laser module 318 emit the red and blue laser beams 428, 430 parallel to the direction of the second dimension D2 of the green laser module 316 and parallel to the initial direction of the green laser beam 426. Additionally, in contrast to the above described embodiments, the first achromatic folding mirror 408 is used to reflect the blue laser beam 430 ninety degrees, not the red laser beam 428. The red laser beam 428 propagates directly through the first dichroic mirror 410 and the second dichroic mirror 414.

One skilled in the art will recognize that many variations of the embodiments described above may be obtained by changing the positions of the folding mirrors 408, 412 and dichroic mirrors 410, 414, 502 and changing the spectral properties of the dichroic mirrors from reflective to transmissive of particular wavelengths. Accordingly, the invention described herein should not be construed as limited by the four permutations shown in FIGS. 4-7, and should be construed as limited only by the appended claims.

FIG. 8 is a fragmentary perspective view of a prism 802 that directs light to the photo-detector 328 used in the optics modules shown in FIGS. 4-7 according to an embodiment of the invention. In the embodiment shown in FIG. 8 the photo-detector 328 is a bare chip 804. The prism 802 includes a groove 806 for accommodating the bare chip 804 photo-detector 328 which is surface mounted on the rigid substrate board 402. The prism 802 is supported on the rigid substrate board 402 and may be affixed thereto with an adhesive (not shown). A leaked portion of the combined combined three color laser beam 434 enters a first face 808 of the prism 802 that extends generally upward from the rigid substrate board 402 and is reflected by a second face 810 of the prism 802 to the bare chip 804 photo-detector 328. The second face 810 is suitably be angled (e.g., at 45 degrees) for total internal reflection. The prism 802 can be made inexpensively out of molded transparent plastic, or alternatively out of glass. The prism 802 redirects laser light propagating substantially parallel to, but displaced from the rigid substrate board 402 to the bare chip 804 on the rigid substrate board 402. The groove 806 allows the position of the prism 802 to be adjusted along the direction parallel to the groove in so that the three color combined laser beam 434 will be incident on the bare chip 804 photo-detector 328. Alternatively the grove 806 can be replaced by a bottom recess to accommodate the photo detector.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A color laser system for a handheld electronic device comprising:
a first laser module having a first dimension and a second dimension that is transverse to said first dimension, said first laser module emitting a first laser beam substantially parallel to said first dimension;
a second laser module disposed at a position within an extent of said first laser module parallel to said second dimension;
a beam combiner optical system for combining said first laser beam and said second laser beam into a multi-color laser beam.

2. The color laser system according to claim 1 wherein, said second laser module is oriented to emit a second laser beam not parallel to said first dimension.

3. The color laser system according to claim 2 wherein said second laser module is oriented to emit said second laser beam substantially perpendicular to said first laser beam.

4. The color laser system according to claim 1 further comprising:
a photo-detector arranged to collect light from said first laser beam and said second laser beam that is leaked by said beam combiner.

5. The color laser system according to claim 4 wherein said beam combiner optical system comprises a dichroic mirror adapted to substantially reflect said first laser beam and substantially transmit said second laser beam, and said photo-detector is arranged to collect a transmitted portion of said first laser beam and a reflected portion of said second laser beam.

6. The color laser system according to claim 4 wherein said beam combiner optical system comprises a dichroic mirror adapted to substantially transmit said first laser beam and substantially reflect said second laser beam, and said photo-detector is arranged to collect a reflected portion of said first laser beam and a transmitted portion of said second laser beam.

7. The color laser system according to claim 4 wherein said beam combiner optical system comprises a dichroic mirror set at 45 degrees to said first laser beam and said second laser beam.

8. The color laser system according to claim 4 further comprises a single printed flexible printed circuit electrically coupled to said first laser module, said second laser module and said photo-detector.

9. The color laser system according to claim 1 further comprising a lens disposed between said first laser module and said beam combiner for modifying said first laser beam.

10. The color laser system according to claim 9 wherein said lens is a compound lens.

11. The color laser system according to claim 1 further comprising:
a third laser module disposed at a position within the extent of said first laser module parallel to said second dimension, said third laser module oriented to emit a third laser beam perpendicular to said first dimension.

12. The color laser system according to claim 1 wherein said first laser module comprises a diode pumped frequency doubled green laser.

13. The color laser system according to claim 1 further comprising a folding mirror arranged to reflect said multi-colored laser beam in a pre-determined direction to a beam scanner.

14. A laser system for a handheld electronic device comprising:
a substrate board;
a laser module supported on said substrate board, said laser module arranged to emit light substantially parallel to said substrate board;
a photo-detector mounted on said substrate board;
a prism overlying said photo-detector, wherein said prism is arranged to intercept a portion of light emitted by said laser module and redirect said portion of light to said photo-detector.

15. The laser system according to claim 14 wherein said prism is supported on said substrate board and said prism has a bottom recess for accommodating said photo-detector.

16. The laser system according to claim 14 wherein said prism is made out of light transmissive plastic.
